(19) United States
(12) Patent Application Publication
(10) Pub. No.: US 2002/0001102 A1
(43) Pub. Date: Jan. 3, 2002

(54) Personalized event book

(76) Inventor: Eddie H. Williams, Fountain Hills, AZ (US)

Correspondence Address: Brett A. Carlson, Snell & Wilmer L.L.P., One Arizona Center, 400 East Van Buren, Phoenix, AZ, 85004-2202, US

(21) Appl. No.: 09/895,741

(22) Filed: Jun. 29, 2001

Related U.S. Application Data
(60) Provisional application No. 60/215,464, filed on Jun. 30, 2000.

(51) Int. Cl. G06F 15/00

(52) U.S. Cl. 358/1.18; 358/1.1

(57) ABSTRACT

According to various aspects of the invention, a personalized magazine commemorating an event includes a plurality of pages, each of the pages comprising at least one photograph related to the event and textual matter associated with the at least one photograph, wherein the plurality of pages are bound together to create the personalized magazine. According to further aspects of the invention, a method of creating a personalized book describing an event includes the steps of gathering content about the event, inputting the content into a computer to create digital data, processing the digital data to format a personalized event book and printing the personalized event book on a printer.

### FIELD OF THE INVENTION

The invention relates generally to personalized publications. More particularly, the invention relates to a personalized book or magazine and to a method of creating the same.

### BACKGROUND OF THE INVENTION

Gatherings such as weddings, birthday celebrations, anniversaries, baptisms, bar and bat mitzvahs, family reunions and the like are joyous events in which people gather to celebrate a special event, or to enjoy the company of friends and family. Often, such events require great amounts of planning and coordination, and constitute the most memorable days of the celebrant's life. Clearly it would be desired to have a reminder/momento of such events to aid in the recall of special days. Common momentos include photographs, which are typically difficult (or at least expensive) to duplicate and distribute. Other momentos include programs, invitations, guest lists, and the like, but these items typically do not provide the “complete” story of the event that is to be remembered. Past attempts to document special events with booklets or the like have been prohibitively expensive, or of poor quality due to the lack of quality printing/duplicating equipment. It is therefore desired to create a customized momento for a special event that fully describes the particular event and that can be readily and economically produced and distributed to family, friends and others.

### BRIEF DESCRIPTION OF THE DRAWING FIGURES

The above and other features and advantages of the present invention are hereinafter described in the following detailed description of illustrative embodiments to be read in conjunction with the accompanying drawing figures and appendices, wherein like reference numerals are used to identify the same or similar parts in the similar views, and:

FIG. 1 is a block diagram of an exemplary production system for a personalized event book;

FIG. 2 is a flowchart of a process for creating a personalized event book; and

FIGS. 3A-J are examples of pages for a personalized event book.

### DETAILED DESCRIPTION OF EXEMPLARY EMBODIMENTS

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, PASCAL, Java, assembler, PERL, PHP, any database programming language or the like, with the various algorithms being implemented with any combination of data structures, objects, processes, routines or other programming elements. Similarly, the invention could be used in conjunction with any type of personal computer, network computer, workstation, minicomputer, mainframe, or other computer running any version of Windows, MacOS, BeOS, Linux, UNIX, Solaris or any other operating system. Further, it should be noted that the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP-6, NetBIOS, OSI or any number of existing or future protocols.

It should be appreciated that the particular implementations shown and described herein are illustrative of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical personalized event book.

To simplify the description of the exemplary embodiments, the invention is frequently described as pertaining to a personalized book or magazine for a wedding. It will be appreciated, however, that many applications of the present invention could be formulated. For example, the personalized book/magazine could be used to describe any special events such as weddings, birthday celebrations, anniversaries, baptisms, first communions, confirmations, bar and bat mitzvahs, family reunions, events in which people gather to celebrate special events or to enjoy the company of friends and family, or the like. Alternatively, the personalized book/magazine could describe a childhood, a career, a childbirth, a school career, or any other period of time. Moreover, the personalized event book may be described herein as being created by a computerized process, although any computerized, manual, hand-processed or automatic techniques may be used.

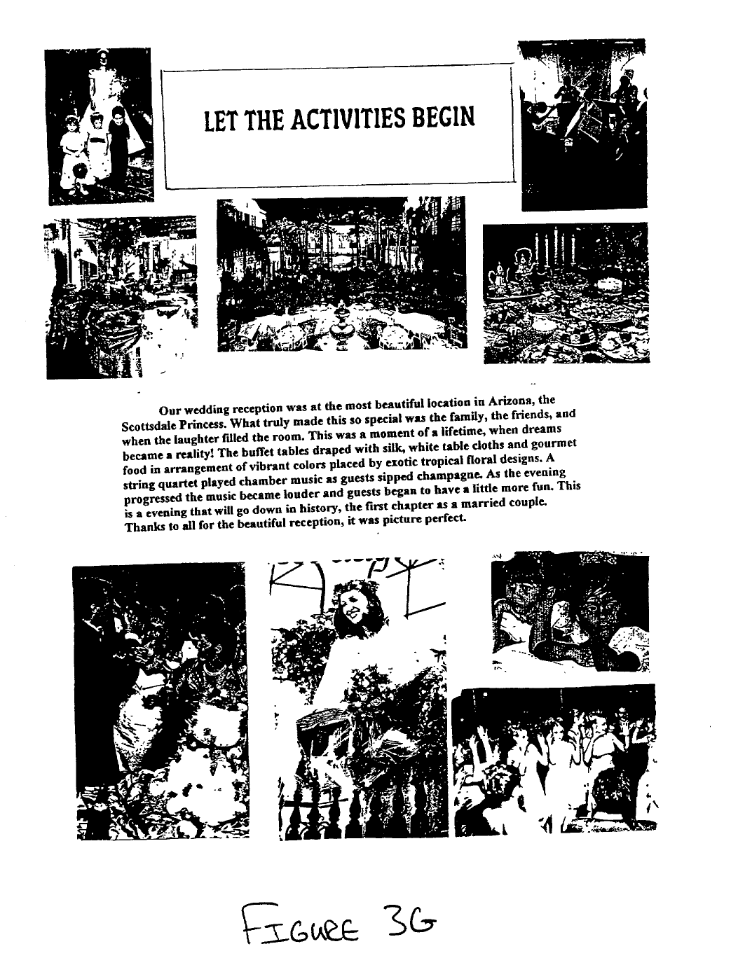

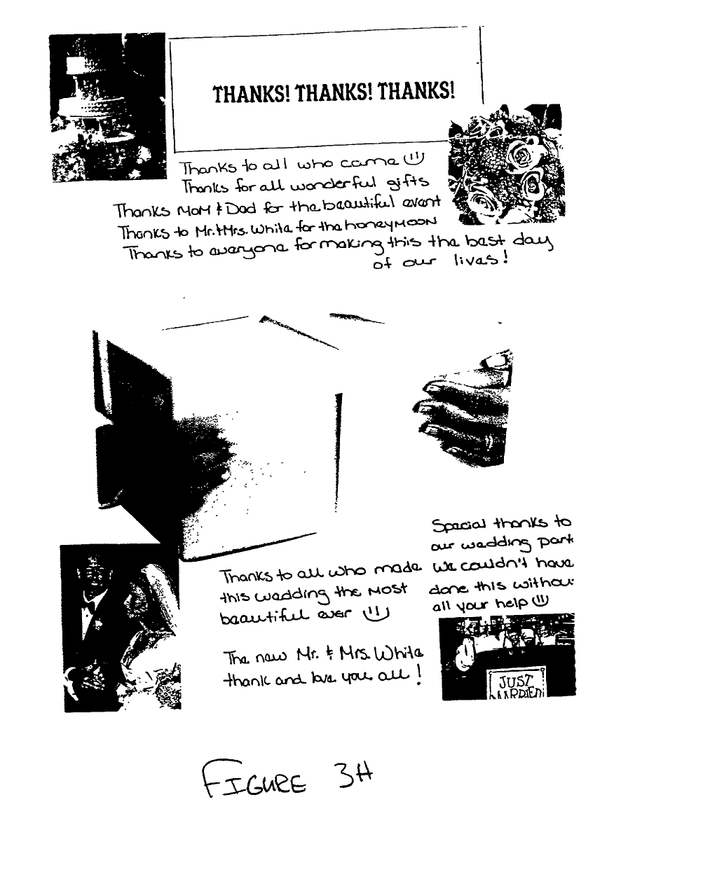

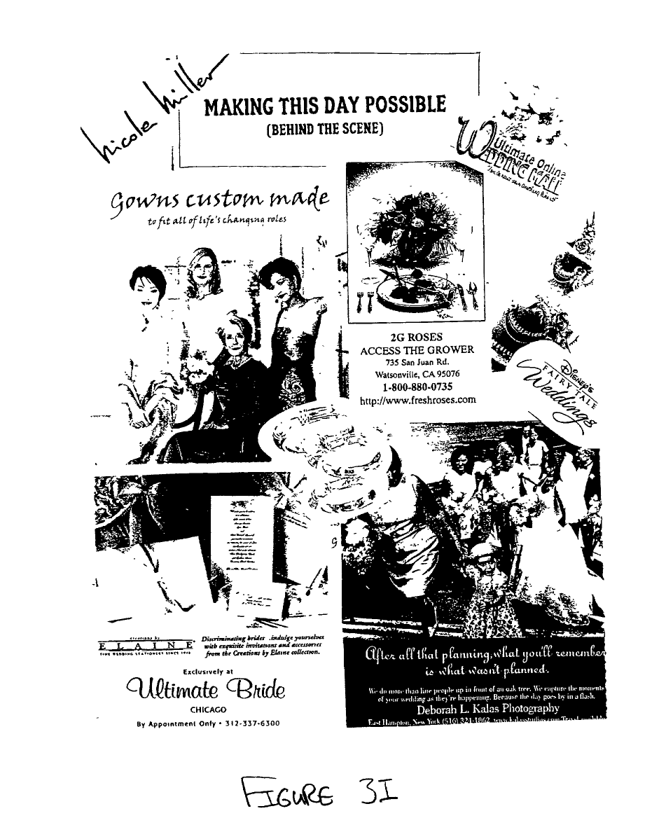

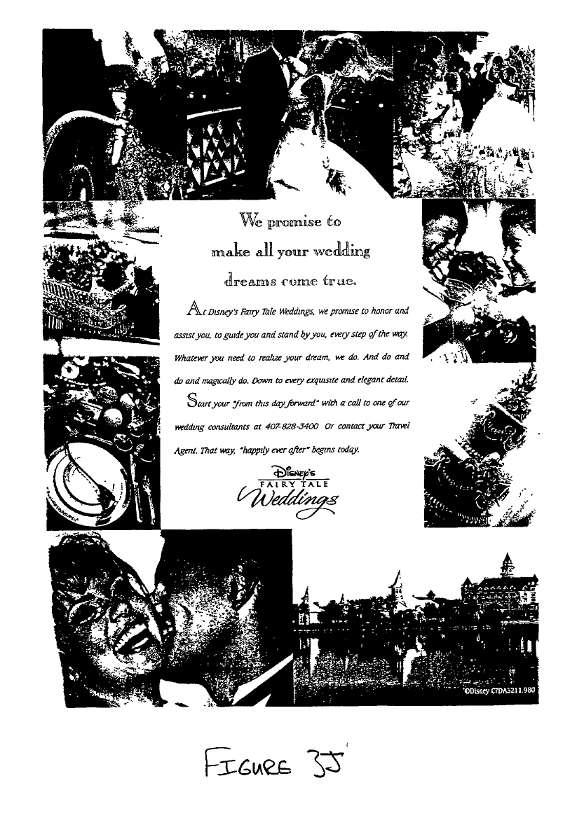

An example of a number of pages from an exemplary personalized book suitable for use as a wedding momento are shown in FIGS. 3A-J. With reference to FIGS. 3A-J, an exemplary personalized book suitably includes photographs, copies of invitations, programs, schedules, guest lists and the like, letters or notes from participants in the event, textual descriptions of the event, and the like. Of course the content of any particular personalized book will vary significantly based upon the event, cost constraints, availability of content, the personal tastes of the participants, and the like. Content may be assembled or organized into any appropriate format, such as the format shown in FIG. 3, or any other suitable format. The content may be assembled onto 8 ½″×11″ pages, legal size pages, A4 size pages, pages of custom sizes, or pages of any other size. In an exemplary embodiment, content is laid out on 11″×17″ pages that can be folded in half, assembled together and stapled or otherwise bound to create a magazine. Alternatively, the pages may be assembled in any other manner such as by tape binding, spindle binding, stapling, glue binding or the like.

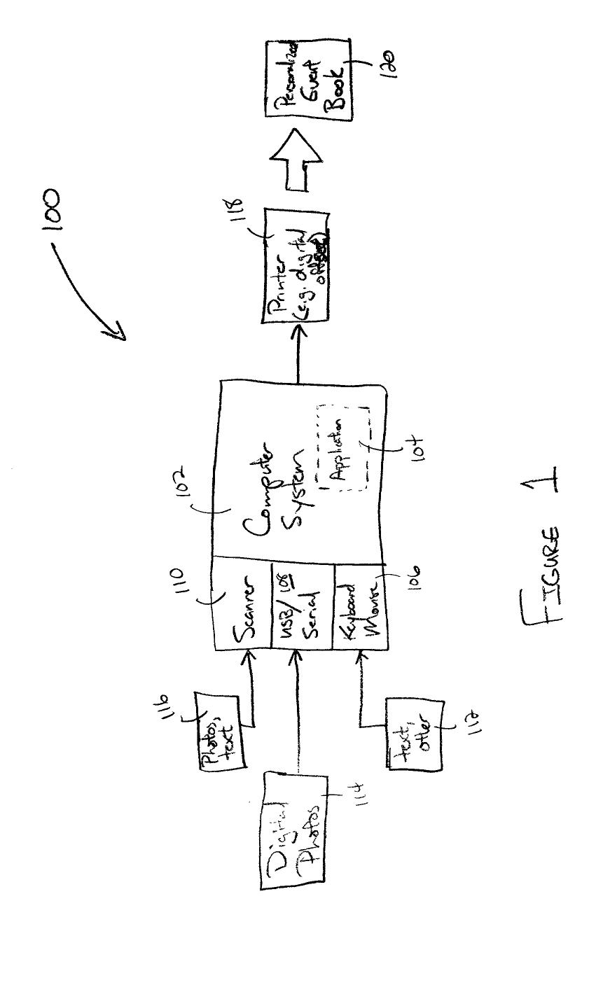

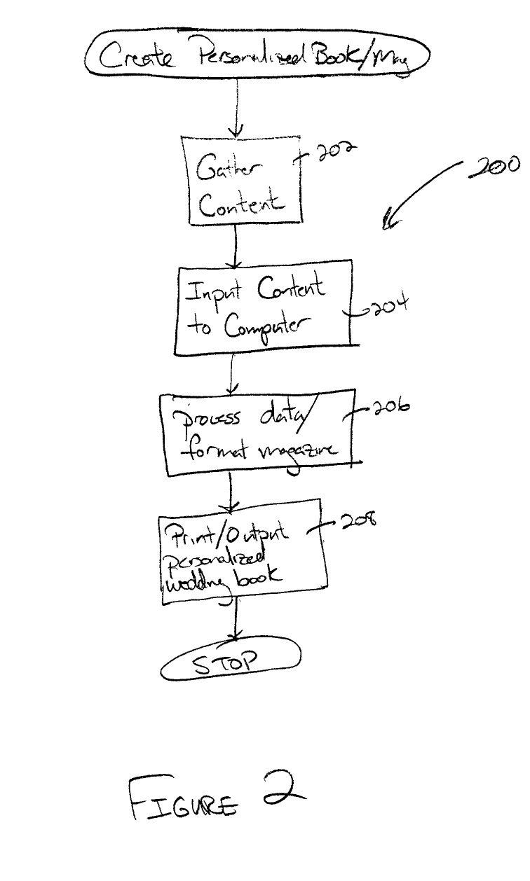

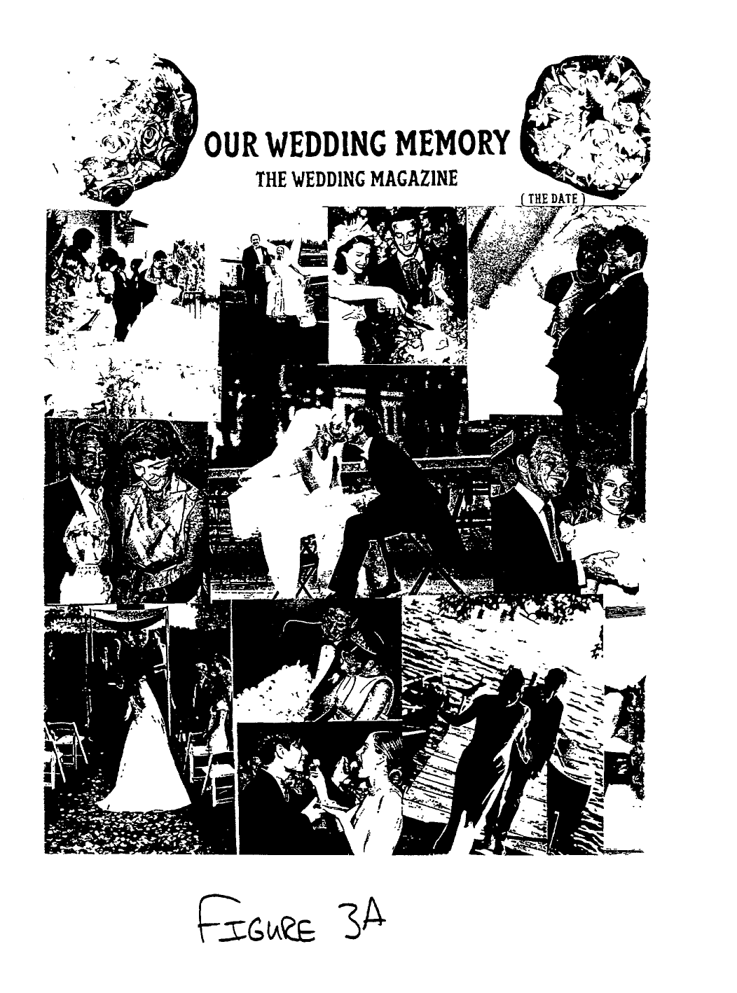

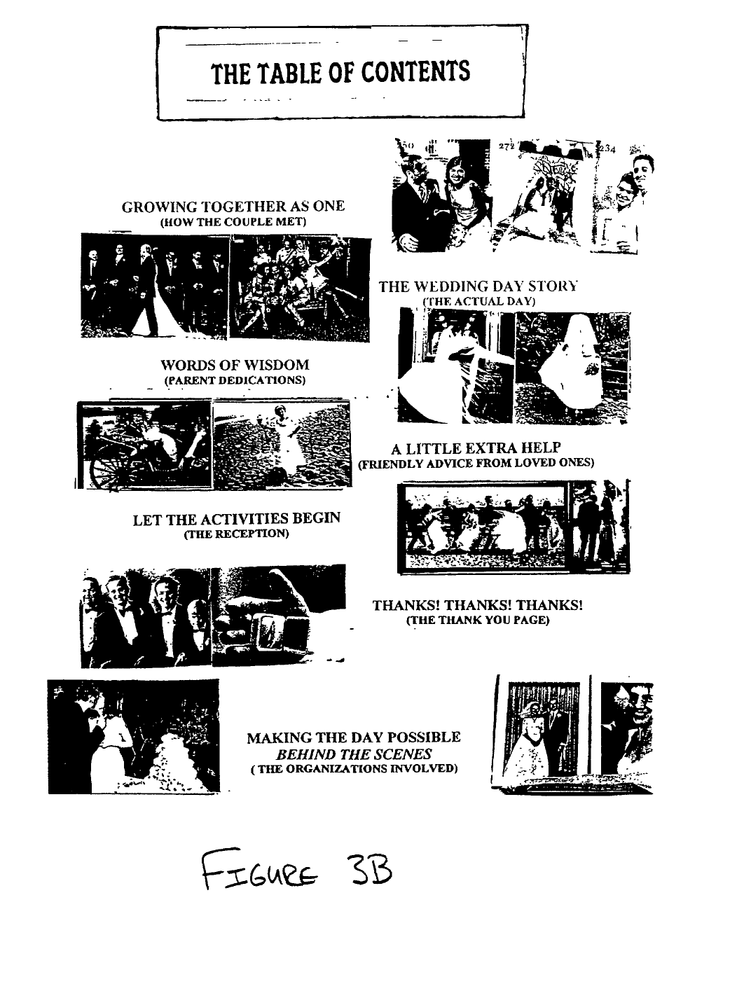

FIG. 1 is a block diagram of an exemplary system for creating personalized event books and/or magazines. With reference to FIG. 1, an exemplary system 100 for creating a personalized book 120 suitably includes a computer system 102 having a software application 104 configured to process the digital information as described herein, and a printer (such as a digital offset printer) that is configured to print pages that can be assembled into a personalized book. Of course, the specific components used in any particular system will vary from embodiment to embodiment.

Computer system 102 is any workstation, personal computer or the like that will typically include a display, hard drive or other storage device, and any type of processor. Computer system 102 may be configured with a scanner 110, a USB or serial port 108, a keyboard, mouse and/or other input device 106 for obtaining inputs from a user. System 102 will also typically include an operating system (such as any version of Linux, Unix, Windows, BeOS, NeXTstep, Solaris, MacOS or the like) as well as software configured to receive and process the digital content.

Content intended for incorporation into personalized event book 120 may be received at computer system 102 from one or more data sources. Photos, invitations and other physical materials 116 may be scanned on a conventional scanner 110 in communication with system 102. Digital photos may be directly downloaded to system 102 via a universal serial bus (USB), serial, parallel or other port 108 on system 102. Alternatively, photos may be obtained from a digital camera at another computer system (not shown) and transferred to system 102 via email, file transfer protocol (FTP) or any other network technique. In still other embodiments, digital photos are received at system 102 via floppy disk or other removable media. Content is suitably stored on server 102 for processing by application 104.

Conventional software applications 104 for processing the digital content may include the Photoshop, Pagemaker or Illustrator programs available from the Adobe corporation of Mountain View, Calif., or any other commercially available desktop publishing and/or image formatting software. Alternatively, customized software 104 may be created to obtain, process, format and output the digital content into a personalized event book according to the methods set forth below, or according to any other technique. Such a software application typically operates by retrieving digital content (such as input text, photographs, images or the like) from memory or disk and by manipulating and formatting the context in response to inputs from an operator/user. In various embodiments, application 104 suitably formats the content into a desired personalized wedding book/magazine having one or more pages. Each of these pages may then be stored as “camera ready” artwork or in any appropriate format that may be read by printer 118.

Printer 118 is any printing device capable of receiving formatted digital content from computer system 118 and of providing a high-quality printed output suitable for use as a personalized event book momento. In an exemplary embodiment, printer 118 is a digital offset printer such as the TurboStream printer available from the Indigo corporation, or any other printer. Such printers are typically capable of processing high-quality digital color output at a high speed without prohibitively high costs of processing.

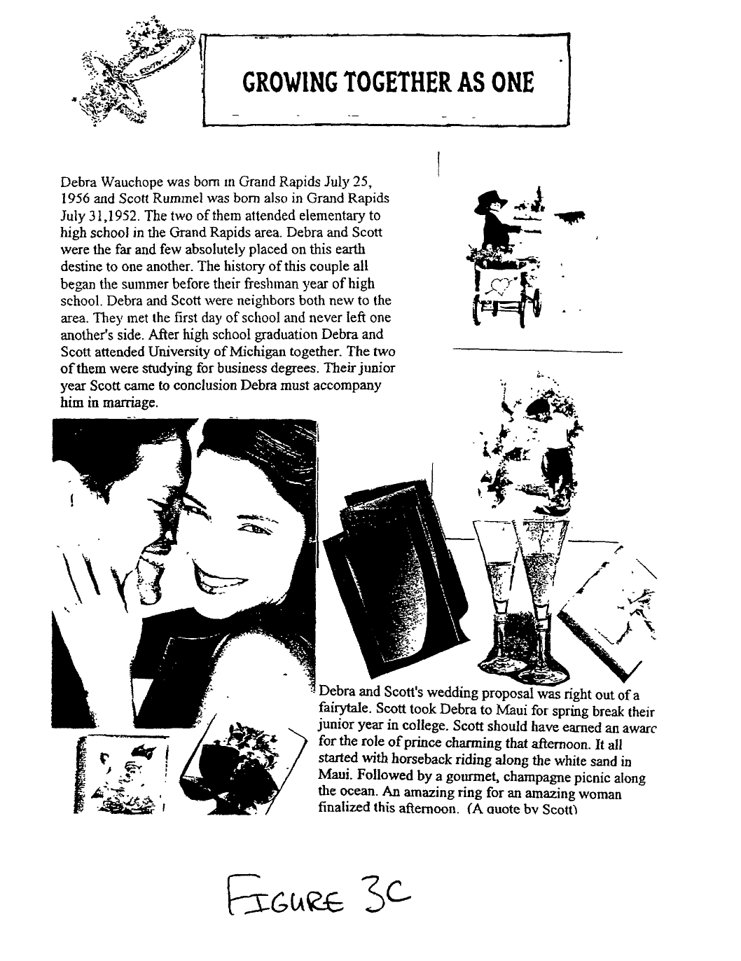

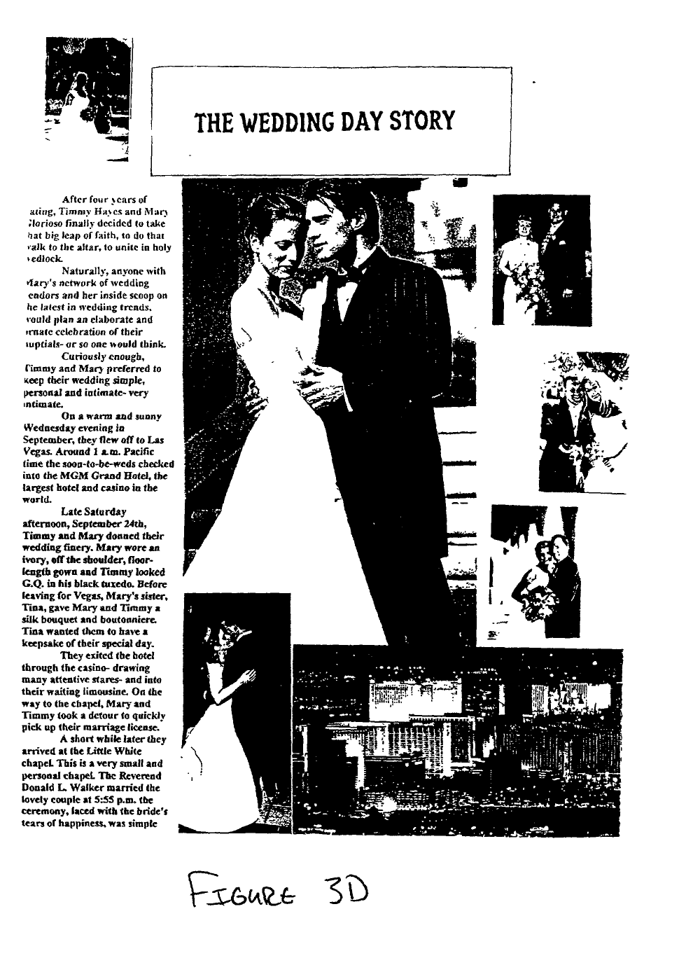

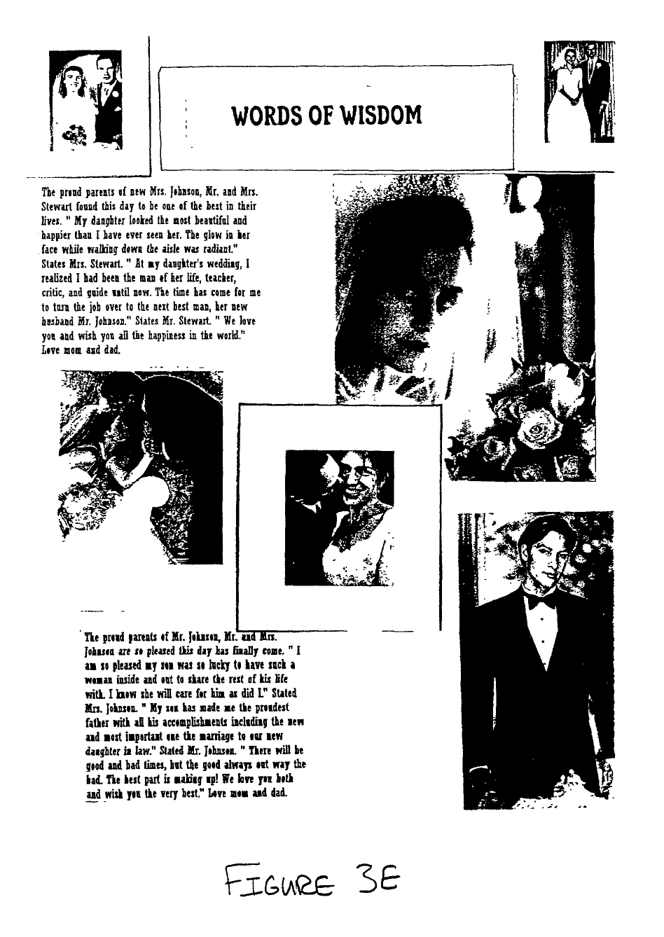

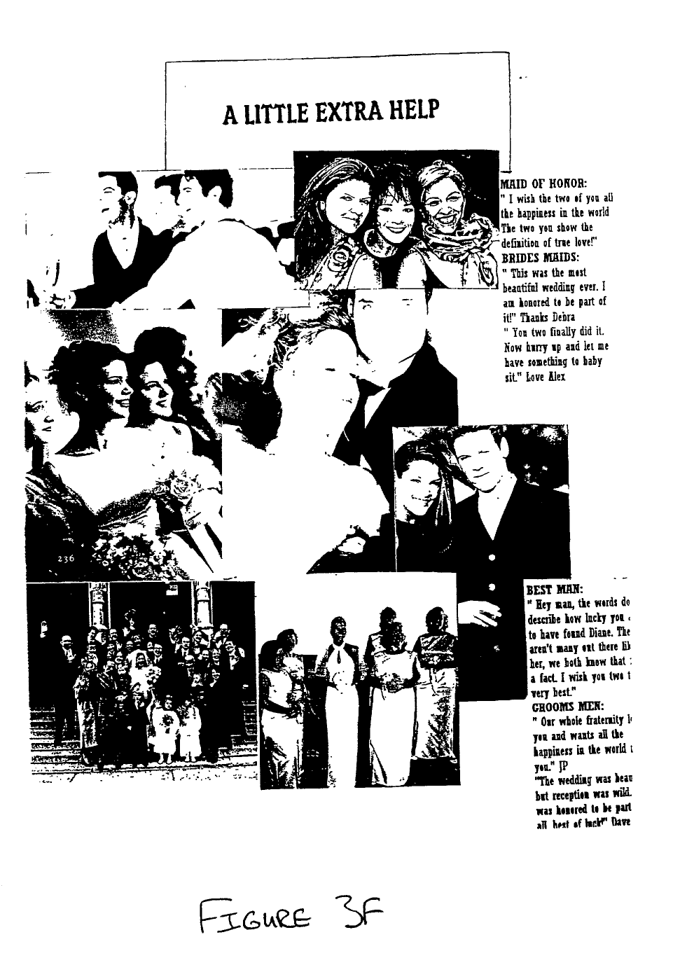

FIG. 2 is a flowchart of an exemplary process for creating a personalized event book. With reference now to FIG. 2, an exemplary process for creating a personalized event book suitably includes the steps of gathering content (step 202), inputting the content into a computer system to create digital data (step 204), manipulating the digital data to format a personalized event book (step 206), and printing the personalized event book on a printer (step 208).

Step 202 of gathering content suitably includes taking digital or analog photographs, writing written descriptions of the event, obtaining information from event participants, and the like. In various embodiments, the step of gathering content suitably includes interviewing event participants or requesting that event participants complete a questionnaire with personal information. The personal information may include name, address, phone number, email address, and the like, and may also include information tailored to the particular event (e.g. when the participant first met the guest of honor, a story about the guest of honor, a special message to an honored guest, or the like). For example, a bride may be asked to provide childhood photos or stories, messages to her parents and guests, or the like. Event hosts or others may also be requested to write thank you messages, welcome messages, or other messages to event guests or participants.

Step 204 of inputting content into a computer system to create digital data suitably includes transferring digital photographs from a digital camera; scanning analog photographs; scanning, typing or otherwise inputting textual data; and the like. In various embodiments, the digital data is stored on a hard drive or other storage device so that the data may be later retrieved by processing software 104 (FIG. 1).

Step 206 of processing the digital data to create a personalized event book 120 suitably includes viewing, manipulating, sorting, formatting or otherwise processing the digital data so that the personalized wedding book takes on a desired format and appearance. In various embodiments, Adobe Pagemaker, Illustrator, or Photoshop software may be used to create a desired appearance. It will be appreciated that the pages of the personalized event book may be processed or manipulated in any manner using any custom or commercially-available software. When the personalized event book is formatted, various embodiments will be formatted into pages that conform to pages that may be output by a computer printer. For example, the pages may be in Postscript format conforming to conventional magazine page sizes suitable for output to a commercial printer. In other embodiments, the computer system provides “camera-ready” art that is capable of printing on a digital offset printer, or any other device. Alternatively (or in addition), the pages may be formatted in hypertext markup language (HTML) for output to a web page for viewing across a digital network such as the Internet.

Step 208 of printing the personalized wedding book suitably includes transferring the formatted pages of the personalized wedding book to a printer for output. Printing may be accomplished on any black and white or color printer is such as an ink jet printer, laser printer, or the like. Of course the type of printer used will vary depending upon the number of copies desired, equipment available, and the particular format of the personalized wedding book. In various embodiments, the formatted personalized event book is printed on a commercially available high-speed laser printer or digital offset printer such as a TurboStream offset printer available from the Indigo corporation, or any other printer. Such embodiments may allow for high-speed color printing of high-quality images suitable for a personalized event book. Digital offset printers and the like suitably provide high-quality, high-speed output at a reasonable price, thus allowing multiple copies of the book to be created and printed for distribution to event participants.

After the pages of the personalized event book are printed, the pages may be collated, sorted and/or assembled to form the bound personalized event book. Pages may be bound by any binding technique such as staples, glue, tape, spiral bind, or any other technique. The bound event books/magazines may then be distributed to participants in the event, to family or friends, or to others having an interest in the event. It will be appreciated that the use of digital processing and digital offset printing suitably allows for a high-quality product that was not previously available with conventional printing technologies. Moreover, the digital offset printer is capable of processing multiple copies of the wedding books 120 at a reasonable price, thus allowing for personalized books to be distributed widely to participants in the event.

In alternate embodiments, the formatted personalized event book 120 may be output to a server on the Internet for viewing by event guest. In such embodiments, the event book 120 may be stored in an appropriate format (such as the hypertext markup language (HTML)) and distributed across the network via conventional hypertext transport protocol (HTTP) techniques. Event guests and other interested parties suitably view the personalized event book online using a conventional web browser such as Netscape Communicator or Internet Explorer.

The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. No element described in this specification is necessary for the practice of the invention unless specifically described herein as “essential” or “required”.

What is claimed is:

1. A method of creating a personalized book describing an event, the method comprising the steps of:
gathering content about said event;
inputting said content into a computer to create digital data;
processing said digital data to format a personalized event book; and
printing said personalized event book on a printer.

2. The method of claim 1 wherein said printer is a digital offset printer.

3. The method of claim 1 further comprising the step of printing multiple copies of said personalized event book on said printer.

4. The method of claim 3 further comprising the step of distributing said copies to participants in said event.

5. The method of claim 1 wherein said content comprises photographs.

6. The method of claim 5 wherein said photographs are arranged and incorporated into said personalized event book.

7. The method of claim 6 wherein said personalized event book further comprises textual material about said event.

8. A personalized magazine commemorating an event, the magazine comprising a plurality of pages, each of said pages comprising at least one photograph related to said event and textual matter associated with said at least one photograph, wherein said plurality of pages are bound together to create said personalized magazine.

9. A personalized magazine of claim 8 wherein said textual matter and said at least one photograph are integrated into a common page layout.

10. A personalized magazine of claim 9 wherein said textual matter and said at least one photograph are integrated by a computer application.

11. A personalized magazine of claim 9 wherein said plurality of pages are printed on a digital offset printer.

12. A digital storage medium having computer-executable instructions stored thereon, wherein said instructions are configured to execute the method of claim 1.

13. A digital storage medium having computer-executable instructions stored thereon, wherein said instructions are configured to execute the method of claim 4.

14. A digital storage medium having computer-executable instructions stored thereon, wherein said instructions are configured to execute the method of claim 6.
